(19) United States
(12) Patent Application Publication
(10) Pub. No.: US 2026/0233564 A1
(43) Pub. Date: Aug. 13, 2026

(54) BI-DIRECTIONAL HITCH WITH ACTIVE LATERAL ANGLE CONTROL

(71) Applicant: GM Global Technology Operations LLC, Detroit, MI (US)

(72) Inventor: Wade W. Bryant, Grosse Point Farms, MI (US)

(73) Assignee: GM Global Technology Operations LLC, Detroit, MI (US)

(21) Appl. No.: 19/049,589

(22) Filed: Feb. 10, 2025

(51) Int. Cl. B60D 1/32; B60D 1/36; B60D 1/42; B60D 1/48

(52) U.S. Cl. CPC B60D 1/32; B60D 1/36; B60D 1/42; B60D 1/481

(57) ABSTRACT

A hitch assembly includes a stationary ring and a first hitch connector. The stationary ring is disposed at a body of a first vehicle. The first hitch connector is movably disposed at the stationary ring and is configured to rotate relative to the stationary ring about a concentric axis of the stationary ring. The first hitch connector includes a receiving portion and a latching portion. The receiving portion includes a pin, an upper tab rotatably fixed to the pin, a lower tab rotatably fixed to the pin, and a damping mechanism. The latching portion includes a clamp configured to engage a pin of a second hitch connector disposed at a second vehicle to attach the second vehicle to the hitch assembly. With the clamp engaging the pin of the second hitch connector, the first hitch connector and the second hitch connector are configured to pivot relative to one another.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a hitch assembly, and specifically, a bi-directional hitch assembly for a vehicle such as an independently powered vehicle, a train car, a trailer, a cart, or something of the like.

Transporting goods from one location to another location may be facilitated by two or more vehicles that are connected to one another and that are configured to travel together as a single unit along a route. For example, a train or chain of vehicles may include multiple vehicles that are configured to transport manufacturing components within a manufacturing facility, such as for transporting vehicle components within a vehicle assembly plant. In another example, the train of vehicles may be configured to transport manufacturing components from one manufacturing facility to another manufacturing facility and travel along a road between the manufacturing facilities.

When traveling along a ground or road surface, a train of vehicles may encounter uneven or undulating terrain. These undulating surfaces can affect each vehicle in the train differently at any given moment. As the train of vehicles moves over these uneven surfaces, the vehicles may shift or move relative to one another to varying degrees to accommodate the changes in the road surface. This phenomenon necessitates a connection between the vehicles that can adapt to these changes, ensuring the train of vehicles can travel efficiently and successfully over undulating road surfaces.

For instance, a road surface with a raised or elevated section may cause one or more vehicles to become overloaded or bind, thereby restricting or inhibiting the train's movement. Conversely, a road surface with a recessed or dipped section may result in one or more vehicles losing contact with the road, reducing the train's traction. Additionally, undulating road surfaces may be encountered on portions of a route that include turns, requiring the train of vehicles to flex in response to the undulations while simultaneously changing direction. Therefore, there is a need for hitches that can manage undulating road surfaces and routes that include turns or changes in direction.

### SUMMARY

One aspect of the disclosure provides a hitch assembly. The hitch assembly includes a stationary ring and a first hitch connector. The stationary ring is disposed at a body of a first vehicle. The first hitch connector is movably disposed at the stationary ring and is configured to rotate relative to the stationary ring about a concentric axis of the stationary ring. The first hitch connector includes a receiving portion and a latching portion. The receiving portion includes a pin extending along a first horizontal axis perpendicular to the concentric axis, an upper tab rotatably fixed to the pin, a lower tab rotatably fixed to the pin, and a damping mechanism configured to resist movement of the upper tab and the pin in a first direction about the first horizontal axis and to resist movement of the lower tab and the pin in a second direction about the first horizontal axis opposite the first direction. The latching portion includes a clamp configured to engage a pin of a second hitch connector disposed at a second vehicle to attach the second vehicle to the hitch assembly, wherein, with the clamp engaging the pin of the second hitch connector, the respective pins of the first hitch connector and the second hitch connector are axially aligned with one another and the first hitch connector and the second hitch connector are configured to pivot relative to one another about the first horizontal axis.

Implementations of this aspect of the disclosure may include one or more of the following optional features. In some examples, the latching portion further includes an actuator configured to pivot the clamp about a second horizontal axis parallel to the first horizontal axis between (i) an engaged state, where the clamp engages the pin of the second hitch connector disposed at the second vehicle, and (ii) a disengaged state, where the clamp is pivoted away from the pin of the second hitch connector to detach the hitch assembly from the second vehicle.

In some implementations, the first hitch connector and the second hitch connector include a mechanical rotation limit feature configured to limit rotation of the first hitch connector and the second hitch connector relative to one another about the first horizontal axis.

In some configurations, the damping mechanism includes an upper tab damper disposed between the upper tab and a lower surface of a housing of the receiving portion and a lower tab damper disposed between the lower tab and an upper surface of the housing. In some further configurations, rotation of the upper tab and the pin in the first direction compresses the upper tab damper and rotation of the lower tab and the pin in the second direction compresses the lower tab damper. In some even further configurations, compression of the upper tab damper and compression of the lower tab damper resists pivoting of the first hitch connector and the second hitch connector relative to one another about the first horizontal axis. In some other further configurations, damping of the upper tab damper and the lower tab damper is adjusted based on a current angle between the first hitch connector and the second hitch connector. In some other further configurations, damping of the upper tab damper and the lower tab damper is adjusted based on sensor data representative of a ground surface ahead of the first vehicle.

In some examples, the hitch assembly further includes an actuator assembly disposed at the body of the first vehicle and configured to rotate the first hitch connector relative to the stationary ring about the concentric axis.

In some implementations, the hitch assembly includes a pair of first hitch connectors movably disposed at the stationary ring. Each first hitch connector of the pair of first hitch connectors is configured to attach the first vehicle to another respective hitch connector of another vehicle.

Another aspect of the disclosure provides a first vehicle. The first vehicle includes a hitch assembly. The hitch assembly includes a stationary ring and a first hitch connector. The stationary ring is disposed at a body of the first vehicle. The first hitch connector is movably disposed at the stationary ring and is configured to rotate relative to the stationary ring about a concentric axis of the stationary ring. The first hitch connector includes a receiving portion and a latching portion. The receiving portion includes a pin extending along a first horizontal axis perpendicular to the concentric axis, an upper tab rotatably fixed to the pin, a lower tab rotatably fixed to the pin, and a damping mechanism configured to resist movement of the upper tab and the pin in a first direction about the first horizontal axis and to resist movement of the lower tab and the pin in a second direction about the first horizontal axis opposite the first direction. The latching portion includes a clamp configured to engage a pin of a second hitch connector disposed at a second vehicle to attach the second vehicle to the hitch assembly, wherein, with the clamp engaging the pin of the second hitch connector, the respective pins of the first hitch connector and the second hitch connector are axially aligned with one another and the first hitch connector and the second hitch connector are configured to pivot relative to one another about the first horizontal axis.

Implementations of this aspect of the disclosure may include one or more of the following optional features. In some examples, the latching portion further includes an actuator configured to pivot the clamp about a second horizontal axis parallel to the first horizontal axis between (i) an engaged state, where the clamp engages the pin of the second hitch connector disposed at the second vehicle, and (ii) a disengaged state, where the clamp is pivoted away from the pin of the second hitch connector to detach the hitch assembly from the second vehicle.

In some implementations, the first hitch connector and the second hitch connector include a mechanical rotation limit feature configured to limit rotation of the first hitch connector and the second hitch connector relative to one another about the first horizontal axis.

In some configurations, the damping mechanism includes an upper tab damper disposed between the upper tab and a lower surface of a housing of the receiving portion and a lower tab damper disposed between the lower tab and an upper surface of the housing. In some further configurations, rotation of the upper tab and the pin in the first direction compresses the upper tab damper and rotation of the lower tab and the pin in the second direction compresses the lower tab damper.

Yet another aspect of the disclosure provides a train assembly. The train assembly includes a first vehicle and a second vehicle. The first vehicle has a hitch assembly including a stationary ring and a first hitch connector. The stationary ring is disposed at a body of the first vehicle. The first hitch connector is movably disposed at the stationary ring and is configured to rotate relative to the stationary ring about a concentric axis of the stationary ring. The first hitch connector includes a receiving portion and a latching portion. The receiving portion includes a pin extending along a first horizontal axis perpendicular to the concentric axis, an upper tab rotatably fixed to the pin, a lower tab rotatably fixed to the pin, and a damping mechanism configured to resist movement of the upper tab and the pin in a first direction about the first horizontal axis and to resist movement of the lower tab and the pin in a second direction about the first horizontal axis opposite the first direction. The latching portion includes a clamp. The second vehicle has a hitch assembly including a stationary ring and a second hitch connector. The stationary ring is disposed at a body of the second vehicle. The second hitch connector is movably disposed at the stationary ring and is configured to rotate relative to the stationary ring about a concentric axis of the stationary ring. The second hitch connector includes a receiving portion and a latching portion. The receiving portion includes a pin extending along a first horizontal axis perpendicular to the concentric axis, an upper tab rotatably fixed to the pin, a lower tab rotatably fixed to the pin, and a damping mechanism configured to resist movement of the upper tab and the pin in a first direction about the first horizontal axis and to resist movement of the lower tab and the pin in a second direction about the first horizontal axis opposite the first direction. The latching portion includes a clamp. The clamp of the first vehicle is configured to engage the pin of the second vehicle and the clamp of the second vehicle is configured to engage the pin of the first vehicle to attach the hitch assembly of the first vehicle to the hitch assembly of the second vehicle. With the hitch assembly of the first vehicle attached to the hitch assembly of the second vehicle, the respective pins of the first hitch connector and the second hitch connector are axially aligned with one another and the first hitch connector and the second hitch connector are configured to pivot relative to one another about the first horizontal axis.

Implementations of this aspect of the disclosure may include one or more of the following optional features. In some examples, the latching portion further includes an actuator configured to pivot the clamp about a second horizontal axis parallel to the first horizontal axis between (i) an engaged state, where the clamp engages the pin of the second hitch connector disposed at the second vehicle, and (ii) a disengaged state, where the clamp is pivoted away from the pin of the second hitch connector to detach the hitch assembly from the second vehicle.

In some implementations, the first hitch connector and the second hitch connector include a mechanical rotation limit feature configured to limit rotation of the first hitch connector and the second hitch connector relative to one another about the first horizontal axis.

In some configurations, the damping mechanism includes an upper tab damper disposed between the upper tab and a lower surface of a housing of the receiving portion and a lower tab damper disposed between the lower tab and an upper surface of the housing. In some further configurations, rotation of the upper tab and the pin in the first direction compresses the upper tab damper and rotation of the lower tab and the pin in the second direction compresses the lower tab damper.

### BRIEF DESCRIPTION OF THE DRAWINGS

The drawings described herein are for illustrative purposes only of selected configurations and are not intended to limit the scope of the present disclosure.

FIG. 1 is a side-view of a train of vehicles according to the present disclosure traveling along a road surface;

FIG. 2A is a perspective view of a hitch assembly of a first vehicle according to the present disclosure;

FIG. 2B is a perspective view of a first hitch connector included at the hitch assembly of FIG. 2A;

FIGS. 3A-3D are perspective views of the first hitch connector of FIG. 2B and a second hitch connector of a second vehicle as the first vehicle and the second vehicle are moved toward one another and clamps of the first hitch connector and the second hitch connector are adjusted from a disengaged state to an engaged state to connect the first vehicle and the second vehicle; and

FIG. 4 is another perspective view of the first hitch connector of the first vehicle and the second hitch connector of the second vehicle fully engaged with one another and connecting the first vehicle to the second vehicle.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

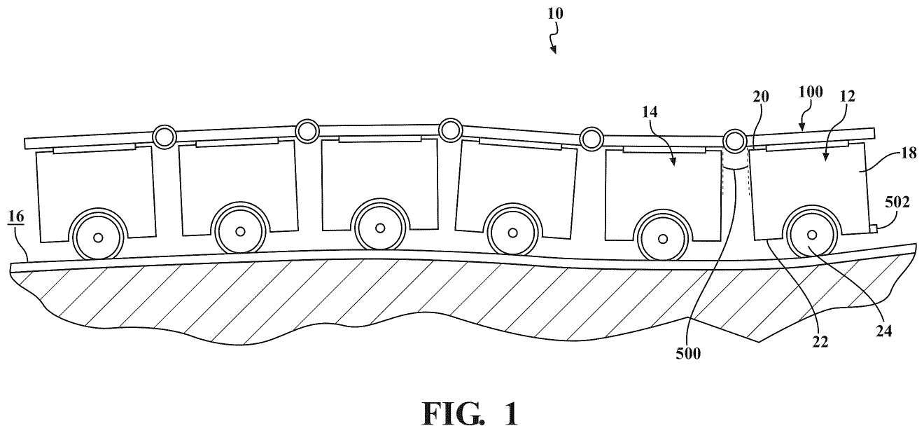

With reference to FIG. 1, a train or chain of independent vehicles (referred to herein as a road train or train assembly 10) includes two or more vehicles, such as a first vehicle 12 and a second vehicle 14, connected to one another successively in a direction of travel. The train assembly 10 is configured to travel as a single unit along a ground surface 16, such as a road, a pathway, or something of the like, with each vehicle of the train assembly 10 disposed behind or in front of an adjacent vehicle. In this regard, adjacent vehicles of the train assembly 10 are configured to be hitched or otherwise connected to one another front-to-back. The first vehicle 12 and the second vehicle 14 are positioned adjacent to one another within the train assembly 10. Additionally, the first vehicle 12, the second vehicle 14, and any additional vehicles of the train assembly 10 may include a compilation of identical or varying vehicles such as, for example, independently powered or driven vehicles, non-powered or non-driven carts, trailers, and the like. For purposes of clarity within this disclosure, elements and characteristics described herein will be associated with the first vehicle 12 unless otherwise noted. However, it should be appreciated that characteristics of the first vehicle 12 may be interchangeable with the second vehicle 14 or any other vehicle included at the train assembly 10. Further, it should be appreciated that the first vehicle 12 and the second vehicle 14 may be included at any position of the train assembly 10 while remaining adjacent to one another. In the illustrated example, the first vehicle 12 is in a leading or front position of the train assembly 10 and the second vehicle 14 is in a second or following position of the train assembly 10.

The first vehicle 12 includes a body 18 that may be differently configured based on the application of the train assembly 10. In other words, the configuration of the body 18 may correspond to the specific material intended to be carried by the first vehicle 12. For example, the body 18 may be configured to transport cargo pallets, raw material, assembled components, or anything as necessitated by the specific application of the first vehicle 12. The body 18 of the first vehicle 12 includes an upper end portion 20 and a lower end portion 22 opposite the upper end portion 20. The lower end portion 22 is positioned closer to the ground surface 16 than the upper end portion 20 during operation of the train assembly 10. Further, a caster or wheel assembly 24 or something of the like may be included at the first vehicle 12 and disposed at or near the lower end portion 22 to facilitate movement of the first vehicle 12 along the ground surface 16. For example, the vehicle 12 may include two independently driven wheel assemblies 24 at opposing sides of the body 18 that are configured to drive the vehicle 12 in a forward direction of travel, a rearward direction of travel, and to pivot or turn the vehicle 12 (e.g., by driving the wheels 24 at different speeds and/or in different directions relative to one another).

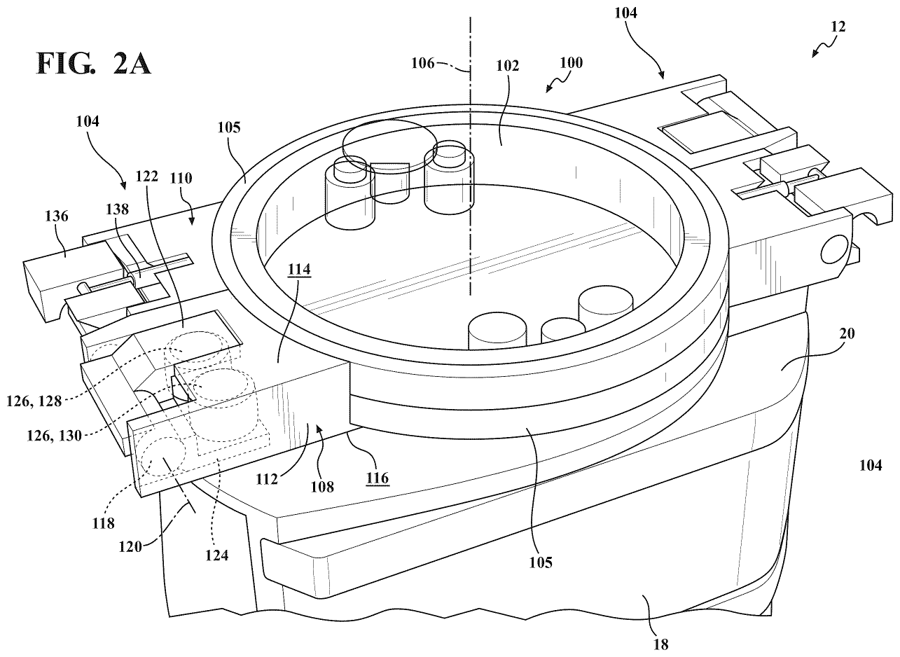

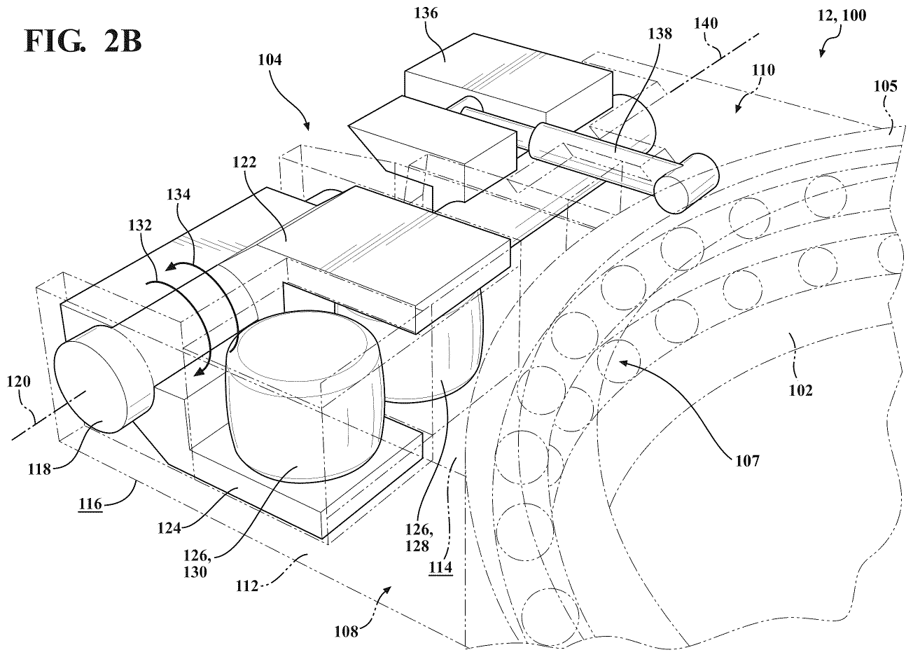

With reference to FIGS. 1-2B, the first vehicle 12 includes a hitch assembly 100 disposed at the upper end portion 20 of the body 18. The hitch assembly 100 is configured to connect to the hitch assembly 100 at another, adjacent vehicle to facilitate joining the first vehicle 12 with adjacent vehicles within the train assembly 10, such as joining the first vehicle 12 with the second vehicle 14. As discussed further below, the hitch assembly 100 is bi-directional and, thus, includes a clamping or engaging portion that engages a receiving portion of another hitch assembly 100 and the hitch assembly 100 includes a receiving portion to be engaged by a clamping or engaging portion of the other hitch assembly 100. Thus, the hitch assembly 100 allows the vehicle 12 to be disposed at any position within the train assembly 10. Moreover, at least a portion of the hitch assembly 100 is pivotable relative to the body 18 of the vehicle 12 to allow the connected vehicles of the train 10 to pivot and turn relative to one another. While the hitch assembly 100 as described herein is included at the first vehicle 12, it should be appreciated that the hitch assembly 100 may be included at any vehicle within train assembly 10.

The hitch assembly 100 includes a stationary ring 102 disposed at the upper end portion 20 of the body 18 of the first vehicle 12. The stationary ring 102 is fixed to the upper end 20 and is configured to remain stationary relative to the body 18. A first hitch connector 104 is movably disposed at the stationary ring 102 and may at least partially or fully circumscribe the stationary ring 102. The first hitch connector 104 is configured to rotate relative to the stationary ring 102 about a concentric axis 106 of the stationary ring 102 that extends in a vertical direction perpendicular to a plane of the stationary ring 102. For example, the first hitch connector 104 may include a movable ring 105 at least partially circumscribing the stationary ring 102 and that moves along an outer surface of the stationary ring 102, such as due to a ball bearing interface 107 disposed between the outer surface of the stationary ring 102 and an inner surface of the movable ring 105. Rotation of the first hitch connector 104 relative to the stationary ring 102 enables the first vehicle 12 to turn relative to the second vehicle 14 or relative to any vehicle adjacent to the first vehicle 12 during travel of the train assembly 10, such as when the train assembly 10 is navigating a turn or a change in direction. For example, the first hitch connector 104 may freely rotate about the stationary ring 102 according to movement or turning of the first vehicle 12 relative to the second vehicle 14. To partially or fully assist in rotating the first hitch connector 104 relative to the stationary ring 102 and the body 18, such as to position the first hitch connector 104 for attachment to another hitch assembly 100, an actuator assembly 26 may be disposed at the body 18 of the first vehicle 12 at or near the stationary ring 102 and the first hitch connector 104, such as at the upper end portion 20 of the body 18. The actuator assembly 26 is configured to rotate the first hitch connector 104 relative to the stationary ring 102 about the concentric axis 106.

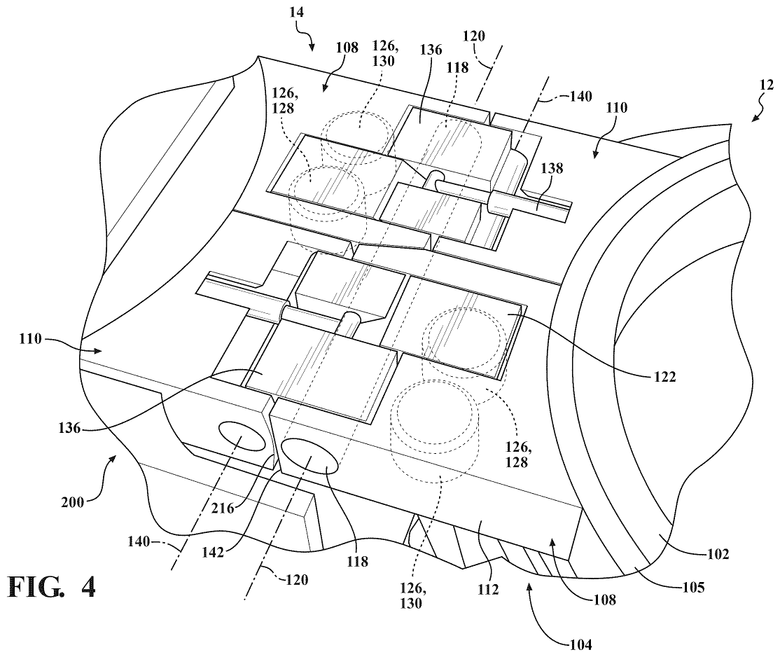

A coupler of the first hitch connector 104 is disposed at the movable ring 105 and includes a receiving portion 108 and a latching portion 110 adjacent to the receiving portion 108. The receiving portion 108 and the latching portion 110 may extend at least partially beyond the body 18 of the first vehicle 12 to facilitate engagement with corresponding receiving portions and latching portions of hitch assemblies 100 disposed at other vehicles when arranged within the train assembly 10. For example, and as shown in FIG. 4, the second vehicle 14 may include a second hitch connector 200 that is configured similarly to the first hitch connector 104. The second hitch connector 200 at the second vehicle 14 may include a coupler having a receiving portion 108 and a latching portion 110 configured similarly to the receiving portion 108 and the latching portion 110 of the first vehicle 12. The receiving portion 108 of the first vehicle 12 may engage with the latching portion 110 of the second vehicle 14 and the latching portion 110 of the first vehicle 12 may engage with the receiving portion 108 of the second vehicle 14, the details of which will be described below.

Further, the hitch assembly 100 may include a pair of first hitch connectors 104 that are independently, movably disposed at the stationary ring 102. For example, each hitch connector 104 of the hitch assembly 100 includes a coupler disposed at a respective movable ring 105 or portion of the movable ring that is independently movable about the stationary ring 102 relative to the other hitch connector 104. In the illustrated example, the movable rings 105 of the pair of hitch connectors 104 are disposed on top of one another or stacked along the concentric axis 106. Accordingly, the body 18 of the vehicle 12 (and the stationary ring 102) may pivot 360 degrees relative to the hitch assembly 100 and the hitch connectors 104 may pivot relative to one another about the stationary ring 102 to a degree less than 360 degrees (such as up to 270 degrees or more) to avoid contact or collisions between the hitch connectors 104. The pair of first hitch connectors 104 enables the first vehicle 12 to simultaneously connect with the second vehicle 14 as well as an additional vehicle included at the train assembly 10. That is, each hitch connector 104 connects to a respective vehicle at the train assembly 10.

The receiving portion 108 includes a housing 112 including an upper surface 114 and a lower surface 116 opposite the upper surface 114. The upper surface 114 is oriented further from the ground surface 16 than the lower surface 116 during operation of the train assembly 10. A pin 118 is disposed at least partially within the housing 112 and extends along a first horizontal axis 120 of the first hitch connector 104 in a direction perpendicular to the concentric axis 106. Further, the receiving portion 108 includes an upper tab 122 and a lower tab 124 that are at least partially disposed within the housing 112. The upper tab 122 is rotatably fixed to the pin 118 and is positioned at or near the upper surface 114. In a similar manner, the lower tab 124 is rotatably fixed to the pin 118 and is positioned at or near the lower surface 116. In this regard, both the upper tab 122 and the lower tab 124 are configured to pivot in conjunction with the pin 118 about the first horizontal axis 120.

A damping mechanism 126 is also included at the receiving portion 108 and contained or accommodated within the housing 112. The damping mechanism 126 is configured to resist rotational movement of the upper tab 122 and the lower tab 124 to control rotation of the pin 118 about the rotational axis 120. For example, the damping mechanism 126 may include air bags/bladders, coil springs, hydraulic cylinders, or something of the like that compresses and expands as the pin 118 rotates about the rotational axis. The damping mechanism 126 may increase resistance as the damping mechanism 126 is compressed. Further, the damping mechanism 126 may include an upper tab damper 128 and a lower tab damper 130. The upper tab damper 128 is disposed between the upper tab 122 and the lower surface 116 of the housing 112, while the lower tab damper 130 is disposed between the lower tab 124 and the upper surface 114 of the housing 112. In this regard, the upper tab damper 128 is configured to resist movement of the upper tab 122 and the pin 118 in a first direction 132 about the first horizontal axis 120 (e.g., clockwise in FIG. 2B), while the lower tab damper 130 is configured to resist movement of the lower tab 124 and the pin 118 in a second direction 134 about the first horizontal axis 120 opposite the first direction 132 (e.g., counterclockwise in FIG. 2B). For example, as the upper tab 122 and the pin 118 rotate about the first horizontal axis 120 in the first direction 132, the upper tab damper 128 compresses between the upper tab 122 and the lower surface 116 of the housing 112. As the upper tab damper 128 is increasingly compressed, rotation of the upper tab 122 and the pin 118 in the first direction 132 is increasingly resisted. In a similar manner, as the lower tab 124 and the pin 118 rotate about the first horizontal axis 120 in the second direction 134, the lower tab damper 130 compresses between the lower tab 124 and the upper surface 114 of the housing 112. As the lower tab damper 130 is increasingly compressed, rotation of the lower tab 124 and the pin 118 in the second direction 134 is increasingly resisted.

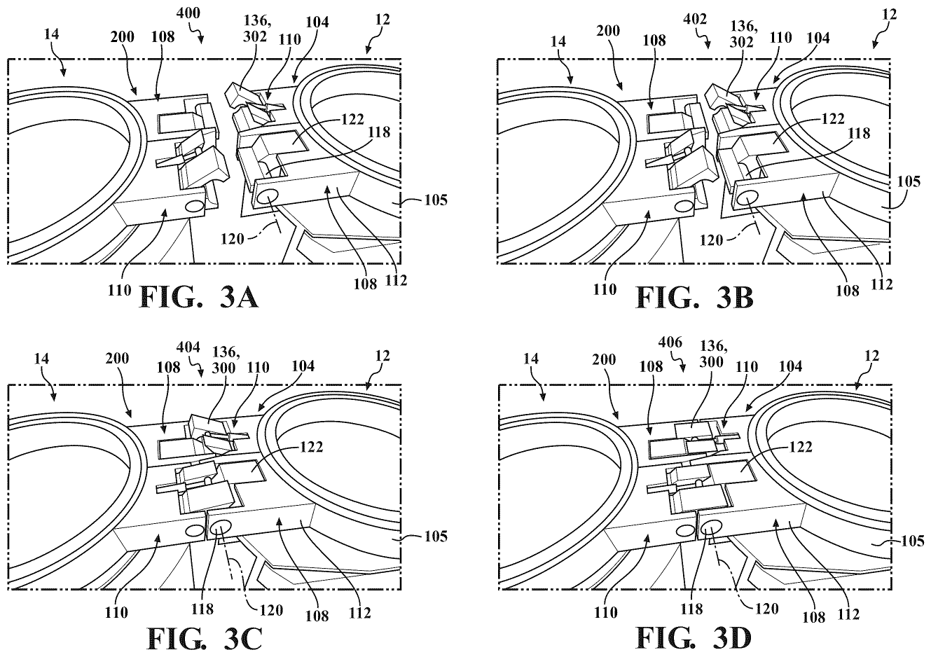

With continued reference to FIGS. 1-2B, and with further reference to FIGS. 3A-4, the latching portion 110 of the first hitch connector 104 includes a clamp 136 configured to engage a pin of another hitch connector included at an adjacent vehicle. For example, the clamp 136 may be configured to engage a pin 118 of the receiving portion 108 included at the second hitch connector 200 of the second vehicle 14. The pin 118 and the receiving portion 108 of the second vehicle 14 are configured similarly to the pin 118 and the receiving portion 108, respectfully, of the first vehicle 12. The latching portion 110 may also include a latch actuator 138 configured to pivot the clamp 136 about a second horizontal axis 140 parallel to the first horizontal axis 120. Pivoting of the clamp 136 about the second horizontal axis 140 transitions the clamp 136 between an engaged state 300 and a disengaged state 302. When the clamp 136 is in the engaged state 300, the clamp 136 may be engaged with the pin 118 of the second vehicle 14, thus connecting the first vehicle 12 with the second vehicle 14. When the clamp 136 is in the disengaged state 302, the clamp 136 is pivoted away from the pin 118 of the second vehicle 14 so that the first vehicle 12 and the second vehicle 14 may be disconnected.

The procedure of connecting the first vehicle 12 with the second vehicle 14 is represented at FIGS. 3A-3D. At the first step 400, the clamp 136 of the first vehicle 12 is in the disengaged state 302 and a clamp 136 included at the latching portion 110 of the second vehicle 14 is also in the disengaged state 302. At the second step 402, the first vehicle 12 and the second vehicle 14 are positioned close to one another to align the pin 118 of the first vehicle 12 with the clamp 136 of the second vehicle 14. In doing so, the clamp 136 of the first vehicle 12 is also aligned with the pin 118 of the second vehicle 14. At the third step 404, the clamp 136 of the first vehicle 12 and the clamp 136 of the second vehicle 14 are transitioned from the disengaged state 302 to the engaged state 300. At the fourth step 406, the clamp 136 of the first vehicle 12 is engaged with the pin 118 of the second vehicle 14 and the clamp 136 of the second vehicle 14 is engaged with the pin 118 of the first vehicle 12. As a result, the pin 118 of the first vehicle 12 and the pin 118 of the second vehicle 14 are axially aligned with one another, thus enabling the first hitch connector 104 and the second hitch connector 200 to pivot relative to one another about the first horizontal axis 120, such as when the train assembly 10 travels along an undulating ground surface 16. For example, the pins 118, 118 may have polygonal or non-rounded shape or contours corresponding to grasping surfaces of the clamps 136, 136 so that the clamps 136, 136 are rotationally fixed to the pins 118, 118 about the first horizontal axis 120 when the hitch connectors 104, 108 are connected to one another.

During operation of the train assembly 10 along a flat surface, such as when the train assembly 10 travels along the ground surface 16 that is free of undulation, the first vehicle 12 and the second vehicle 14 are hitched to one another while remaining free of rotation about the first horizontal axis 120. The upper tab damper 128 and the lower tab damper 130 at the receiving portion 108 of the first vehicle 12 prevent unwanted rotation about the first horizontal axis 120. Further, the receiving portion 108 of the second vehicle 14 may also include a damping mechanism 136 including an upper tab damper 138 and a lower tab damper 140, thus also assisting in preventing unwanted rotation about the first horizontal axis 120. When the train assembly 10 travels along an undulating surface (e.g., FIG. 1), such as when the ground surface 16 includes hills, bumps, valleys, dips, inclines, declines and the like, the first vehicle 12 and the second vehicle 14 remain hitched to one another while rotating about the first horizontal axis 120 to accommodate the ground surface 16. Rotation about the first horizontal axis 120 enables the first vehicle 12 and the second vehicle 14 to individually remain firmly planted to the ground surface 16, regardless of undulation. The damping mechanism 126 at the first vehicle 12 and the damping mechanism 136 at the second vehicle 14 controls rotation about the first horizontal axis 120 and maintains stability between the first vehicle 12 and the second vehicle 14 during travel. That is, the damping mechanism 126 may operate to adjust a level of resistance or damping to adjust how freely the first vehicle 12 and the second vehicle 14 pivot relative to one another about the first horizontal axis 120.

For example, pivoting of the first hitch connector 104 about the first horizontal axis 120 in the first direction 132 may occur when the first vehicle 12 and the second vehicle 14 travel along a recessed dip or a valley. As a result, the upper tab dampers 128, 138 compress and resist rotation of the first hitch connector 104 and the second hitch connector 200, relative to one another, about the first horizontal axis 120. The greater the upper tab dampers 128, 138 compress, the greater the resistance provided by the upper tab dampers 128, 138. In a similar manner, pivoting of the first hitch connector 104 about the first horizontal axis 120 in the second direction 134 may occur when the first vehicle 12 and the second vehicle 14 travel along a raised bump or a hill. As a result, the lower tab dampers 130, 140 compress and resist rotation of the first hitch connector 104 and the second hitch connector 200, relative to one another, about the first horizontal axis 120. The greater the lower tab dampers 130, 140 compress, the greater the resistance provided by the lower tab dampers 130, 140.

With continued reference to FIGS. 1-4, in addition to the resistance provided by the damping mechanisms 126, 136, the first hitch connector 104 may include a first mechanical rotation limit feature 142 and the second hitch connector 200 may include a second mechanical rotation limit feature 144 that are configured to engage with one another at a maximum amount of allowable rotation about the first horizontal axis 120 in either the first direction 132 or the second direction 134. For example, the first mechanical rotation limit feature 142 or the second mechanical rotation limit feature 144 may include a partially curved surface to allow for an acceptable amount of rotation of the first hitch connector 104 and the second hitch connector 200 relative to one another about the first horizontal axis 120. However, a maximum amount of rotation is reached when the first mechanical rotation limit feature 142 and the second mechanical rotation limit feature 144 engage with one another, restricting further rotation of the first hitch connector 104 and the second hitch connector 200 relative to one another, regardless of the damping mechanisms 126, 136.

Damping or resistance provided by the damping mechanisms 126, 136 may be adjusted, such as based on a current angle 500 between the first hitch connector 104 and the second hitch connector 200 at any given moment during travel of the train assembly 10. For example, when the train assembly 10 travels along the ground surface 16 that is free of undulation, the current angle 500 may be at or near zero degrees (that is, the first hitch connector 104 and the second connector 200 may be substantially parallel to one another), and damping of the damping mechanisms 126, 136 may provide relatively stiff resistance to preclude rotation. However, when the train assembly 10 travels along the ground surface 16 that includes undulation, the current angle 500 may fluctuate between non-zero values, and damping of the damping mechanisms 126, 136 may provide relatively loose or flexible resistance to encourage rotation. The amount of damping provided by the damping mechanisms 126, 136 may increase or decrease based on variations of the current angle 500 at any given moment. Alternatively or conjunctively, damping of the damping mechanisms 126, 136 may be adjusted based on sensor data provided by a sensor 502 configured to read the ground surface 16 ahead of the first vehicle 12 at any given moment during travel of the train assembly 10. For example, when the sensor data indicates the ground surface 16 ahead of the first vehicle 12 is flat or free of undulation, damping of the damping mechanisms 126, 136 may provide relatively stiff resistance. However, when the sensor data indicates the ground surface 16 ahead of the first vehicle 12 includes undulation, damping of the damping mechanisms 126, 136 may be adjusted to provide relatively loose or flexible resistance. The amount of damping provided by the damping mechanisms 126, 136 may increase or decrease based on the sensor data provided by the sensor 502 at any given moment.

The train assembly 10 and the hitch assembly 100 described herein may utilize characteristics of the vehicles and systems as described in U.S. Patent Application Ser. No. ______, filed ______, and titled AN EXPANDABLE MODULAR VEHICLE FOR LIFTING AND TRANSPORTING CARGO PALLETS (Attorney Docket No. P108753-PRI-NP-US01), which is incorporated herein by reference in its entirety.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A hitch assembly comprising:
a stationary ring disposed at a body of a first vehicle; and
a first hitch connector movably disposed at the stationary ring, the first hitch connector configured to rotate relative to the stationary ring about a concentric axis of the stationary ring, the first hitch connector including:
a receiving portion including a pin extending along a first horizontal axis perpendicular to the concentric axis, an upper tab rotatably fixed to the pin, a lower tab rotatably fixed to the pin, and a damping mechanism configured to resist movement of the upper tab and the pin in a first direction about the first horizontal axis and to resist movement of the lower tab and the pin in a second direction about the first horizontal axis opposite the first direction; and
a latching portion including a clamp configured to engage a pin of a second hitch connector disposed at a second vehicle to attach the second vehicle to the hitch assembly, wherein, with the clamp engaging the pin of the second hitch connector, the respective pins of the first hitch connector and the second hitch connector are axially aligned with one another and the first hitch connector and the second hitch connector are configured to pivot relative to one another about the first horizontal axis.

2. The hitch assembly of claim 1, wherein the latching portion further includes an actuator configured to pivot the clamp about a second horizontal axis parallel to the first horizontal axis between (i) an engaged state, where the clamp engages the pin of the second hitch connector disposed at the second vehicle, and (ii) a disengaged state, where the clamp is pivoted away from the pin of the second hitch connector to detach the hitch assembly from the second vehicle.

3. The hitch assembly of claim 1, wherein the first hitch connector and the second hitch connector include a mechanical rotation limit feature configured to limit rotation of the first hitch connector and the second hitch connector relative to one another about the first horizontal axis.

4. The hitch assembly of claim 1, wherein the damping mechanism includes an upper tab damper disposed between the upper tab and a lower surface of a housing of the receiving portion and a lower tab damper disposed between the lower tab and an upper surface of the housing.

5. The hitch assembly of claim 4, wherein rotation of the upper tab and the pin in the first direction compresses the upper tab damper and rotation of the lower tab and the pin in the second direction compresses the lower tab damper.

6. The hitch assembly of claim 5, wherein compression of the upper tab damper and compression of the lower tab damper resists pivoting of the first hitch connector and the second hitch connector relative to one another about the first horizontal axis.

7. The hitch assembly of claim 4, wherein damping of the upper tab damper and the lower tab damper is adjusted based on a current angle between the first hitch connector and the second hitch connector.

8. The hitch assembly of claim 4, wherein damping of the upper tab damper and the lower tab damper is adjusted based on sensor data representative of a ground surface ahead of the first vehicle.

9. The hitch assembly of claim 1, further comprising an actuator assembly disposed at the body of the first vehicle and configured to rotate the first hitch connector relative to the stationary ring about the concentric axis.

10. The hitch assembly of claim 1, wherein the hitch assembly includes a pair of first hitch connectors movably disposed at the stationary ring, each first hitch connector of the pair of first hitch connectors configured to attach the first vehicle to another respective hitch connector of another vehicle.

11. A first vehicle comprising:
a hitch assembly including:
a stationary ring disposed at a body of the first vehicle; and
a first hitch connector movably disposed at the stationary ring, the first hitch connector configured to rotate relative to the stationary ring about a concentric axis of the stationary ring, the first hitch connector including:
a receiving portion including a pin extending along a first horizontal axis perpendicular to the concentric axis, an upper tab rotatably fixed to the pin, a lower tab rotatably fixed to the pin, and a damping mechanism configured to resist movement of the upper tab and the pin in a first direction about the first horizontal axis and to resist movement of the lower tab and the pin in a second direction about the first horizontal axis opposite the first direction; and
a latching portion including a clamp configured to engage a pin of a second hitch connector disposed at a second vehicle to attach the second vehicle to the hitch assembly, wherein, with the clamp engaging the pin of the second hitch connector, the respective pins of the first hitch connector and the second hitch connector are axially aligned with one another and the first hitch connector and the second hitch connector are configured to pivot relative to one another about the first horizontal axis.

12. The first vehicle of claim 11, wherein the latching portion further includes an actuator configured to pivot the clamp about a second horizontal axis parallel to the first horizontal axis between (i) an engaged state, where the clamp engages the pin of the second hitch connector disposed at the second vehicle, and (ii) a disengaged state, where the clamp is pivoted away from the pin of the second hitch connector to detach the hitch assembly from the second vehicle.

13. The first vehicle of claim 11, wherein the first hitch connector and the second hitch connector include a mechanical rotation limit feature configured to limit rotation of the first hitch connector and the second hitch connector relative to one another about the first horizontal axis.

14. The first vehicle of claim 11, wherein the damping mechanism includes an upper tab damper disposed between the upper tab and a lower surface of a housing of the receiving portion and a lower tab damper disposed between the lower tab and an upper surface of the housing.

15. The first vehicle of claim 14, wherein rotation of the upper tab and the pin in the first direction compresses the upper tab damper and rotation of the lower tab and the pin in the second direction compresses the lower tab damper.

16. A train assembly comprising:
a first vehicle having a hitch assembly including:
a stationary ring disposed at a body of the first vehicle; and
a first hitch connector movably disposed at the stationary ring, the first hitch connector configured to rotate relative to the stationary ring about a concentric axis of the stationary ring, the first hitch connector including:
a receiving portion including a pin extending along a first horizontal axis perpendicular to the concentric axis, an upper tab rotatably fixed to the pin, a lower tab rotatably fixed to the pin, and a damping mechanism configured to resist movement of the upper tab and the pin in a first direction about the first horizontal axis and to resist movement of the lower tab and the pin in a second direction about the first horizontal axis opposite the first direction; and
a latching portion including a clamp;
a second vehicle having a hitch assembly including:
a stationary ring disposed at a body of the second vehicle; and
a second hitch connector movably disposed at the stationary ring, the second hitch connector configured to rotate relative to the stationary ring about a concentric axis of the stationary ring, the second hitch connector including:
a receiving portion including a pin extending along a first horizontal axis perpendicular to the concentric axis, an upper tab rotatably fixed to the pin, a lower tab rotatably fixed to the pin, and a damping mechanism configured to resist movement of the upper tab and the pin in a first direction about the first horizontal axis and to resist movement of the lower tab and the pin in a second direction about the first horizontal axis opposite the first direction; and
a latching portion including a clamp;
wherein, the clamp of the first vehicle is configured to engage the pin of the second vehicle and the clamp of the second vehicle is configured to engage the pin of the first vehicle to attach the hitch assembly of the first vehicle to the hitch assembly of the second vehicle, and wherein, with the hitch assembly of the first vehicle attached to the hitch assembly of the second vehicle, the respective pins of the first hitch connector and the second hitch connector are axially aligned with one another and the first hitch connector and the second hitch connector are configured to pivot relative to one another about the first horizontal axis.

17. The train assembly of claim 16, wherein the latching portion further includes an actuator configured to pivot the clamp about a second horizontal axis parallel to the first horizontal axis between (i) an engaged state, where the clamp engages the pin of the second hitch connector disposed at the second vehicle, and (ii) a disengaged state, where the clamp is pivoted away from the pin of the second hitch connector to detach the hitch assembly from the second vehicle.

18. The train assembly of claim 16, wherein the first hitch connector and the second hitch connector include a mechanical rotation limit feature configured to limit rotation of the first hitch connector and the second hitch connector relative to one another about the first horizontal axis.

19. The train assembly of claim 16, wherein the damping mechanism includes an upper tab damper disposed between the upper tab and a lower surface of a housing of the receiving portion and a lower tab damper disposed between the lower tab and an upper surface of the housing.

20. The train assembly of claim 19, wherein rotation of the upper tab and the pin in the first direction compresses the upper tab damper and rotation of the lower tab and the pin in the second direction compresses the lower tab damper.
